(19) United States
(12) Patent Application Publication
(10) Pub. No.: US 2026/0347958 A1
(43) Pub. Date: Nov. 5, 2026

(54) A METHOD AND AN APPARATUS FOR THE RECOVERY OF PROCESSING WASTE FROM THE TANNING AND LEATHER INDUSTRY

(71) Applicant: GRUB S.R.L., Bergamo (IT)

(72) Inventor: Francesco MICHELACCI, Grumello del Monte (IT)

(21) Appl. No.: 19/487,928

(22) PCT Filed: May 30, 2024
(86) PCT No.: PCT/IB2024/055276

§ 371 Date: Nov. 25, 2025

(30) Foreign Application Priority Data
May 31, 2023 (IT) 102023000011073

(51) Int. Cl. C14C 3/28; C14C 3/04; C14C 3/10; C14C 3/32; C14C 15/00; D01C 3/00

(52) U.S. Cl. CPC C14C 3/28; C14C 3/04; C14C 3/10; C14C 3/32; C14C 15/00; D01C 3/00; D10B 2211/01

(57) ABSTRACT

There are described methods and apparatuses for the regeneration of processing waste from the leather manufacturing industry. Specifically, the present invention refers to apparatuses and methods for the recovery, from hide and leather waste, of fibers which are made fit for spinning and for being used in textile processes.

### FIELD OF THE INVENTION

The present invention refers to the field of the regeneration of processing waste from the tanning and leather industry. Specifically, the present description refers to apparatuses and methods for the recovery, from hide and leather waste, of fibers which are made fit for spinning and for being used in textile processes.

### STATE OF THE ART

The production processes of the leather industry (specifically of the tanning industry) and of the industry for the manufacture of leather goods, such as bags, shoes, belts, wallets etc., lead to a great amount of waste of already tanned hide and of leather, in the form of scraps, cut-out pieces and overhangs; such waste is very difficult to recycle or to dispose of, and therefore they constitute a major environmental problem. Indeed, most of such waste is disposed of in waste-to-energy plants, and no possible recycling is envisaged.

As it is commonly known, the general term of animal hide denotes a macro-category including all the materials obtained from the dermis of a vertebrate mammal (cattle, swine, sheep, goats), and it also comprises leather.

In certain manufacturing sectors, the term “leather” is used to denote vegetable tanned hide, while the term “hide” refers to chemically tanned skin, e.g. by using chrome. The terms “leather” and “hide”, therefore, indicate a different productive process.

Originally, the term “leather” only referred to very rigid vegetable tanned hide, which was employed for manufacturing shoe soles. Nowadays, on the contrary, “leather” refers to any type of vegetable tanned hide.

Generally, therefore, the animal skins are subjected to a tanning operation, which may involve mineral substances—i.e. chrome tanning—and which is carried out using chrome sulphate, or else vegetable substances, employing vegetable or synthetic tannins. In the case of mineral tanning, the tanned hide is typically denoted with the term wet blue due to the light blue colour of chrome, whereas in the case of vegetable tanning the treated leather is denoted as wet white.

If the tanning were not performed, the hide would keep the features of an animal tissue, with obvious problems due to texture—which for its very nature would be too soft—and the degradability induced by temperature, chemical agents and bacteria and microorganisms, which would cause the rotting thereof. By means of tanning, the hide turns into a rot-proof material, which is extremely resistant and keeps its characteristics for a very long time, therefore being adapted to the production of many widespread consumer goods.

The dermis is the skin layer which is transformed by means of tanning. In an animal hide, e.g. bovine hide, the dermis is located underneath the epidermis and constitutes approximately 85% of the total thickness thereof.

The dermis mainly consists of connective tissue, the main component whereof is made of collagen fibers. Moreover, the dermis also contains elastin and other unstructured proteins having a cementing action, such as albumins and globulins, which are removed in the tanning process. The skin component which is most relevant for tanning is collagen, the protein which directly reacts with the substances used in the tanning process. The collagen fibers are the main constituent of the hide ready for tanning.

Collagen is a fibrous protein which is present in the extra-cellular matrix. Each collagen fiber consists of a cluster of fibrils having a diameter of approximately 0.1 μm, and each fibril consists of tropocollagen filaments having a diameter which is a hundred times smaller. Tropocollagen is formed by three polypeptide chains, which are twisted together and compose a triple helix. The isoelectric point, IP, indicates the pH value of the medium wherein the positive and negative charges of the protein are perfectly balanced, and it is the feature which enables to establish the reactivity of the hide during processing. The IP of collagen is approximately 7.5. In baths having a pH higher than this value, the protein will be charged negatively, whereas below 7.5 it will be charged positively. At pH values approaching the collagen IP, collagen exhibits a high chemical-physical inertness: indeed, it tends to react minimally and has the minimum viscosity.

The temperature above which collagen starts to be damaged by the action of water is called gelatinization (or contraction) temperature, gT.

At water temperatures higher than 50° C., indeed, the dermis undergoes serious damage due to the action of water, and the hide tends to contract and twist. At the boiling point of water, after a given period, due to the denaturation of proteins, the dermis melts and originates a gelatinous solution.

By means of tanning, the fibrous structure of the hide is stabilized, and therefore gT increases. The contraction temperature depends on the tanning agent being used: indicatively, for the chrome tanned hides the values of gT will be higher than 100° C., for the vegetable tanned leather gT will amount to about 70° C., and for the leather tanned with glutaraldehyde the value of gT will amount to about 80° C.

As regards the treatment of the processing waste, in the modern textile production chain it is usual to recover textile scraps such as spinning or weaving waste, cut-and-sew waste, used garments etc. by means of a regeneration obtained with a machine such as a fraying machine. This machine comprises a rotating drum covered with metal spikes, which rotates while being in contact with the material to be frayed. The defibering force is opposed by the resistance brought about by at least one driven cylinder, which compresses the material against a suitably shaped steel bar, in such a way as to adequately retain the material and feed it to the cylinder covered by metal spikes.

The traditional fraying machines, however, are not adapted to fray hide or leather waste, because such waste, if it is forcibly retained in the vicinity of the spikes of the rotating cylinders, releases compact lumps of very short fibers, which are hardly usable, if at all, for producing textile goods.

Actually, unsatisfactory results are obtained both by employing traditional fraying machines, which substantially comprise a drum externally covered with steel nails, and by employing fraying/carding machines known as “garnets”, which in the same way comprise a cylinder externally covered with steel spikes which are adapted to transport, in operation, the material to be frayed towards a number of toothed cylinders arranged on the surface thereof.

Better results may be achieved by employing a drum used for tanning hides, which must be suitably covered, on the inside, with spikes withstanding chemical corrosion. The drum is partially filled with the material to be frayed and a solution containing water, acids and salts of different types (having an emollient and swelling action) and sulphonated oils (having a lubricating function, to favour a better extraction of the fibers from the felt of the dermis).

In the operation of such a machine, which may be compared to a drum of a washing machine, the fragments of hide to be treated are slowly frayed by the steel spikes on the inner surface of the drum. Although the fibers obtained with such a drum exhibit a good quality as regards length and strength, the process is very time consuming.

Patent GB1466058 describes a method for treating, by carding, the leather waste after liming and tanning, and for subsequently mixing it with loose particle and textile fibers or asbestos, before proceeding to spinning. The leather waste which is used does not comprise collagen, which is removed chemically together with fat; on the other hand, it comprises the leather split, i.e. the softest layer of the dermis, which is generally discarded from the processing in the leather industry.

Patent GB1134668 describes a method for obtaining collagen fibers from tanning waste. It envisages removing fleshings from the dermis, i.e. the parts of flesh which are still attached to the hide after the skinning, a possible treatment in acid or a decalcification, if necessary the use of enzymes, and a step of tanning, with the removal of fat. The described method subsequently comprises a step of mechanical disintegration in excess of water, and then subsequent steps of fiber opening, partial drying, carding and complete drying, followed by a conversion into textile fibers by employing conventional techniques.

In the methods of the state of the art as described in the documents mentioned in the foregoing, during the tanning process which is carried out before the disintegration step, the dermic tissue tends to astringe and get more compact, therefore making it difficult to extract the fibers which, being close together and bound to one another, tend to tear instead of fraying. As a consequence, the fibers extracted from an already tanned dermic tissue, either of hide or of leather, according to the methods of the state of the art, exhibit a low quality for textile use.

An apparatus according to the preamble of Claim 1 and a method according to the preamble of Claim 9 are known from document IT 10 2012902031413. Another known solution is shown in document US 2019/078233 A1.

An object of the present invention therefore aims at providing a method and an apparatus which are adapted to overcome at least some of the disadvantages of the known art.

### SUMMARY OF THE INVENTION

In order to achieve the aforementioned goal, the object of the invention is an apparatus according to Claim 1 and a method according to Claim 9. The invention moreover concerns the use of the apparatus of Claim 1 according to what is specified in Claim 18.

The apparatuses and the methods according to the present description aim at overcoming all the drawbacks mentioned in the foregoing, in order to obtain, from tanned or untanned leather waste (so-called leather splits), a particular type of fibers to be used in the textile sector.

Said method for the recovery of processing waste from the tanning and leather industry comprises an initial step of collection and division into groups of the waste to be treated. In the case of previously tanned waste, the various waste groups which have been identified are subsequently sent to so-called “detanning” plants, which may be of different types in order to better treat the different types of waste to be processed.

In the case of untanned waste, after collection and division, the treated waste is immersed into a bath preferably containing a glutaraldehyde solution having a concentration between 1% and 5% (as an alternative, it is possible to use other tanning agents, including natural oils) adapted to suitably prepare the waste for the following fraying step, which is carried out by means of an apparatus which is also an object of the present invention.

This apparatus comprises a double chamber, whereof the inner chamber comprises an external perforated surface and an internal rotating drum, which is provided with a plurality of spikes protruding from the surface. In this treatment step, the waste is subjected to the action of the rotating drum while it is immersed in an acidic solution, e.g. an acetic acid-based solution, preferably having a pH between 2.5 and 6.

This acidic bath loosens the tanning and pre-tanning bonds of glutaraldehyde, and helps separating the collagen fibers from one another.

The action of immersed fraying enables extracting long and extended fibers, which are then pushed towards the wall of said inner chamber in order to be filtered and then collected in the outer chamber of the apparatus.

Subsequently, the fibers collected at the end of the previous step are introduced into a drum together with suitable tanning agents. In this step, the fibers are subjected to the action of the tanning agents, which may be mineral agents, such as chrome sulphate, or vegetable agents, such as vegetable or synthetic tannins, adapted to prevent the decomposition of the waste without altering the flexibility and the structure thereof. The continuous rotation of the drum, moreover, favours the impregnation of the fibers with said tanning agents, so as to favour the tanning process.

At the end of this step, the fibers are extracted from the drum and dehydrated by means of a centrifuge—or, as an alternative, by means of a drying machine which is adapted to operate continuously, such as e.g. a belt press—and then they are completely dried by means of hot air jets.

As an alternative, the tanning step may be carried out by means of highly unsaturated oil, e.g. by means of oil obtained from sea animals.

In the latter case, the fibers to be treated are initially pressed, in order to remove any residue of water derived from previous treatments, and then the oil is made to penetrate the fibers by means of mechanical treatments, e.g. by means of baths in hammer drums, they being particular drums the pegs whereof are free to move and to strike against said fibers as the drum rotates.

Finally, the treated fibers are pressed once again, in order to eliminate the oil in excess and, again, they are dehydrated by means of a centrifuge and finally completely dried by means of hot air jets.

### BRIEF DESCRIPTION OF THE FIGURES

Further features and advantages of the invention will be evident in the light of the following detailed description, which is provided by means of non-limiting example only, with reference to the Figures shown in the annexed drawings, wherein:

FIG. 1 shows a preferred embodiment of the fraying machine according to the present description;

FIG. 2 shows a section view of another preferred embodiment of the fraying machine according to the present description;

FIG. 3 shows a section view of another preferred embodiment of the fraying machine according to the present description, and

FIG. 4 shows a section view of another preferred embodiment of the fraying machine according to the present description.

The description of exemplary embodiments provided in the following refers to the annexed drawings. The same reference numbers in various drawings denote the same elements or similar elements. The following detailed description does not limit the invention. The scope of the invention is defined by the annexed Claims.

### DETAILED DESCRIPTION OF THE INVENTION

The method for the recovery of the processing waste from the tanning and leather industry according to the present invention comprises the following steps:
a) Collecting the waste and dividing the waste according to the type of tanning.

This operation is carried out by means of analyses adapted to identify the type of tanning and the type of finish. As regards the type of tanning a determination is made as to whether the leather has been treated by means of mineral tanning—i.e. chrome tanning—by using chrome sulphate (and in this case the treated leather is named wet blue for its light blue colour), or else it has been treated by means of vegetable tanning, by using vegetable or synthetic tannins (and in this case the treated leather is named wet white). As regards the finish, it is established e.g. whether it consists of mating, lamination or print.
b) Detanning. In the case of previously tanned waste, in this step the waste is subjected to a treatment adapted to remove the various tanning agents which are still present, in order to restore said waste to a state as close to the original biological state as possible, in which it is less difficult to extract elongated collagen fibers, instead of having short lumped heaps. In this detanning step, the chrome tanned waste is then treated in an acidic or alkaline environment, to cause the leather to swell, through a hydrolysis process which loosens and separates part of the bonds formed in the tanning process.

For example, in the case of previously chrome-tanned waste, the material may be treated, within a drum, with a bath of low-temperature sulphuric acid, or else with an oxalic acid or toluenesulfonic acid-based bath, if necessary buffered with sodium chloride, at low temperature, e.g. at room temperature. With this process, a part of the chrome is removed and the structure of the fiber bundles of the dermis is loosened. This process achieves a reduction of the chrome present on the treated material, while preserving the structure of the leather. As an alternative, the previously chrome-tanned waste may be treated in an alkaline environment, for example in a caustic soda bath having a pH preferably comprised between 10 and 14 at room temperature (at approximately 20°), then it may be rinsed and drained and finally immersed in an acidic bath, e.g. of oxalic acid, having a pH of about 5-5.5, with the possible addition of albite to impart a light colour to the treated leather.

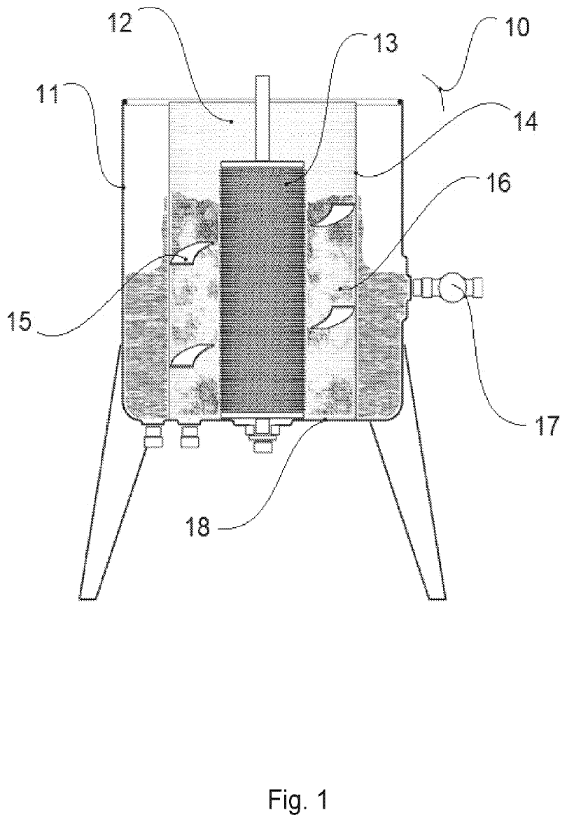

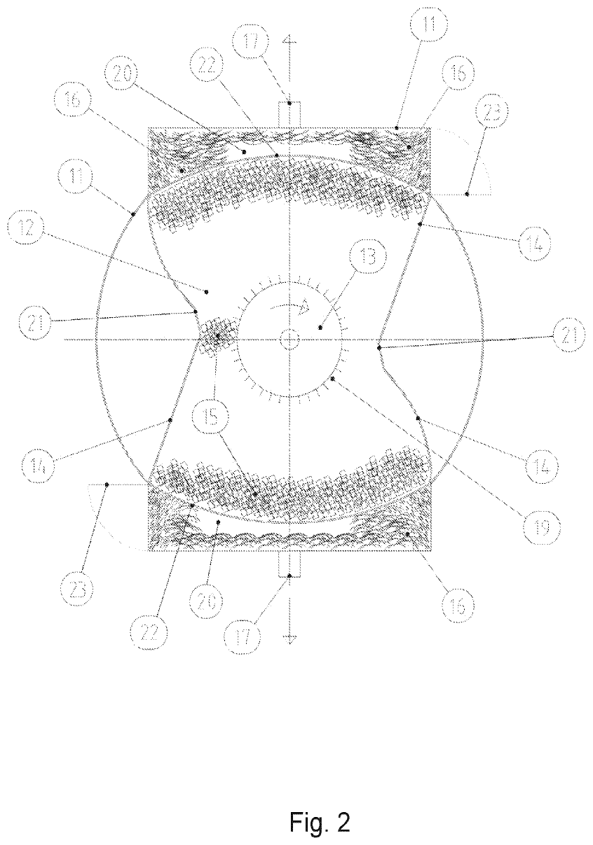

If the waste was previously tanned with a vegetable or metal-free tanning, it can be treated in a sulfuric acid-based bath, or in a bath of salts of pyrophosphoric acid, at low temperature or at room temperature, or in an alkaline bath, e.g. a caustic soda bath having a pH preferably comprised between 12 and 13 at room temperature (around 20°), subsequently rinsed and drained, and if necessary immersed in an albite bath to achieve discoloration; then, again, it is rinsed and drained, and finally immersed again in an alkaline bath having a pH e.g. between 12 and 13, before the final rinse.
c) Treating the detanned waste with a glutaraldehyde solution having a concentration between 1% and 5%, preferably having a pH between 3 and 5. This treatment takes place in small drums preferably made of stainless steel, and it is adapted to strengthen the collagen fibers, compacting them to form long bundles while keeping them separated from each other.
d) Fraying the treated waste so as to obtain elongated leather fibers, adapted to be used in conventional textile carded spinning systems. Preferably, this fraying step is carried out by means of a new fraying machine according to the present description, a preferred embodiment whereof is shown in the annexed FIGS. 1 and 2.
e) Treating the extracted fibers with suitable tanning substances-which may be mineral, such as chrome sulphate, or vegetable, such as vegetable or synthetic tannins which are adapted to prevent the decomposition of the fibers without altering the flexibility and the structure thereof. The treatment may be carried out inside a specific drum.
f) Drying the fibers thus obtained.

Between the aforementioned steps e) and f), i.e. before drying, it is possible to treat the waste with softening substances, in order to make the fibers of said waste more slippery and easily separated from one another.

Preferably, said step f) comprises the following sub-steps:
g) dehydrating the fibers by means of a centrifuge or a continuous process, and
h) drying the fibers in a hot air drying machines.

After step g), the treated material appears as a compact cake of fibers, which before entering the hot air drying machine may be further treated by a special detufting machine, adapted to divide/loosen/untangle the heap of fibers in the fiber cake into groups of ordered fibers.

In a preferred embodiment, shown in the annexed FIG. 1, the detufting machine according to the present invention, which is employed in step d) of the procedure described in the foregoing, comprises:
a main container 10, preferably having a cylindrical or almost cylindrical shape, comprising an outer lateral wall 11, a floor 18 and an inner wall 14 delimiting an inner chamber 12, which may be cylindrical or almost cylindrical as well.

Said inner wall 14 may be substantially coaxial with the main container 10, and is provided with a filter 22 adapted to separate the leather fibers extracted from the treated leather scraps and to favour the transit thereof towards special collection chambers 20, which are external to the inner chamber 12 and which communicate therewith through the filter 22. Said filter may be implemented in a part of the inner wall 14 by means of a plurality of holes or slots, adapted to allow the passage of the leather fibers 16 frayed from the waste 15, but to prevent the passage of the waste 15 itself. In a preferred embodiment, said filter 22 comprises a plurality of slots which are arranged horizontally and therefore wherein the longer side of the slot is arranged substantially horizontally.

Said inner chamber 12, moreover, comprises in its interior at least one rotating drum 13, which is anchored to the floor 18 of the container 10, is controlled by a suitable driving system and is provided, on the outer surface, with metal spikes 19 arranged in a radial direction.

The operation of said fraying machine envisages introducing the treated waste 15 into the inner chamber 12 together with an immersion liquid, so that such waste, carried by the immersion liquid which is kept in motion by the movement of the rotating drum, is subjected by the metal spikes 19 of the controlled rotating drum 13 to a fraying action aiming at extracting the continuous leather fibers, until a complete disintegration is achieved of each leather scrap 15.

The waste 15 opposes a certain resistance to the rotating drum 13 because they are braked by the viscosity of the immersion bath, and this enables the leather fibers of the waste 15 to be gradually hooked by the metal spikes on the rotating drum 13 until the extraction thereof is complete, while avoiding sudden tears and the consequent release of lumps and/or of excessively short fibers.

Said immersion liquid may be an acidic solution (e.g. of acetic acid, and preferably having a pH between 2.5 and 6) or an alkaline solution (e.g. of caustic soda, having a pH preferably between 10 and 14), preferably with the addition of a small amount of collagen.

In a preferred embodiment shown in FIG. 2, said inner chamber 12 is almost cylindrical in shape, and the wall 14 is characterized by at least one recess 21 which narrows the inner chamber 12. At said at least one recess 21, the distance of the inner wall 14 of said inner chamber 12 from the rotating drum 13 is smaller than in other areas of the inner chamber 12 where no recess is provided. At said at least one recess 21, therefore, there is provided a bottleneck, whereat the waste 15 tends to accumulate and therefore to offer a higher resistance to the action of the metal spikes on the rotating drum 13; the latter action, therefore, becomes more effective in extracting the leather fibers 16 of the waste 15.

The scraps 15 passing through the bottleneck are then conveyed, thanks to the effect of the centrifugal thrust imparted by the rotation of the rotating drum 13, towards the part of the wall 14 of the inner chamber 12 which is provided with filters 22.

Now the leather fibers 16, which may be mixed with small amounts of collagen, which have been obtained by means of the fraying process described in the foregoing, are able to pass filter 22. The migration of the leather fibers 16 towards the collection chamber 20 is favoured by the presence of the acidic or alkaline aqueous solution, the mass whereof is pushed in the centrifugal direction by the rotation of the rotating drum 13.

Said suspension of leather fibers 16 in an acidic (or alkaline) aqueous solution, which has some viscosity but which is basically fluid, is pushed into at least one collection chamber 20, which is arranged in the space between the outer wall 11 of the main container 10 and the wall 14 of the inner chamber 12 provided with filters 22, and it is subsequently continuously discharged through at least one discharge sleeve 17 arranged on the lateral surface of the outer wall 11 of said main container 10. Said collection chambers 20 may be provided with openings, with an access hatch 23 to enable easy maintenance and cleaning operations.

The filtering by filter 22 is tangential: the suspension containing the leather scraps 15 and the leather fibers 16 obtained thanks to the action of the drum 13 flows nearly parallel to the filter 22, thereby originating a more effective filtering action due to preventing harmful clogging and turbulence which would hamper the collection of leather fibers 16 and the transit of the suspension containing the leather fibers 16 towards the collection chamber(s) 20.

Moreover, because the discharge sleeve 17 is arranged on the outer lateral wall 11 of said main container 10 in a raised position with respect to the floor 18 of said container 10, it is possible to sustain a suitable flow of the suspension of the leather fibers 16 from the filter 22 of the inner chamber 12, while preventing the holes and/or the slots of said filter 22 from being subjected to clogging and obstructions.

In order to favour the mobility of the leather scraps and frays within the liquid phase they are immersed in, and to facilitate their transit through said bottleneck, it is possible to increase the percentage of the acidic substance (acetic or formic acid) or of the alkaline substance in the solution, or it is possible to add suitable lubricants. As an alternative, it is possible to invert the rotating direction of the drum 13.

Advantageously, the apparatus described in the foregoing may be equipped with a sensor, adapted to detect the viscosity of the suspension of leather fibers 16 in the acidic or alkaline solution, downstream of the filter(s) 22, e.g. at the outlet of said discharge sleeve 17. On the basis of the measured value of the viscosity, it is possible to act in order to make said suspension less viscous, by adding more acidic (or alkaline) solution, or to make it more viscous, by adding other leather scraps to be treated.

Preferably, the bath ratio within said inner chamber 12 of the leather scraps to the acidic or alkaline aqueous solution may vary from 1/3 to 1/4.5. In other words, for 1 kg of leather waste there are used 3 to 4.5 litres of solution.

In another preferred embodiment, the fraying machine according to the present invention is provided with a system for regulating the temperature of the bath contained in the inner chamber 12. As a matter of fact, the described method is more effective is the bath temperature is kept below 45°-50° C. For example, a system for thermal regulation with water may be installed with heat exchanger contacting the wall 14 of the inner chamber 12 of said main container 10. Such systems for thermal regulation are known in the art and will not be described in detail in the present specification.

The structure of the inner chamber 12 may be variously implemented while making use of the inventive teaching provided in the foregoing. In a preferred embodiment, said inner chamber 12 has a wall 14 characterized by two recesses which form two bottlenecks, as shown in the annexed FIG. 2.

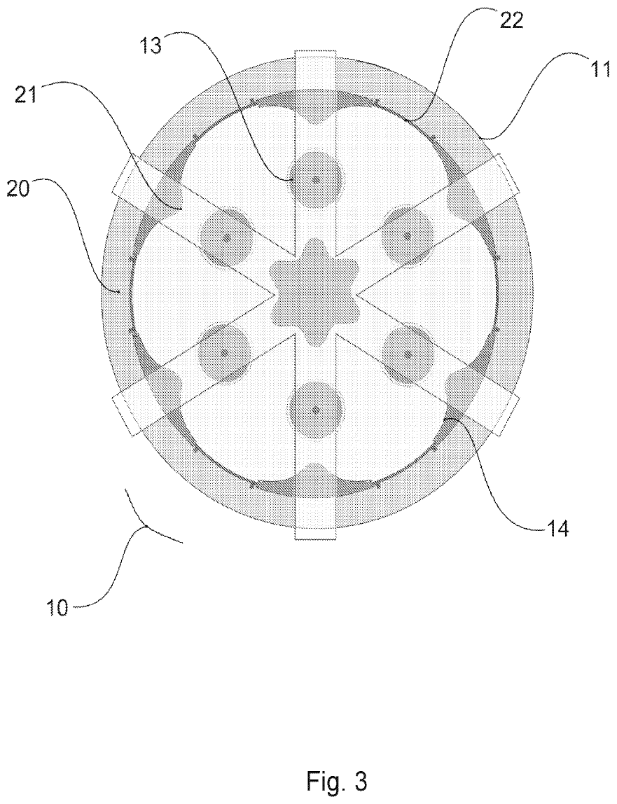

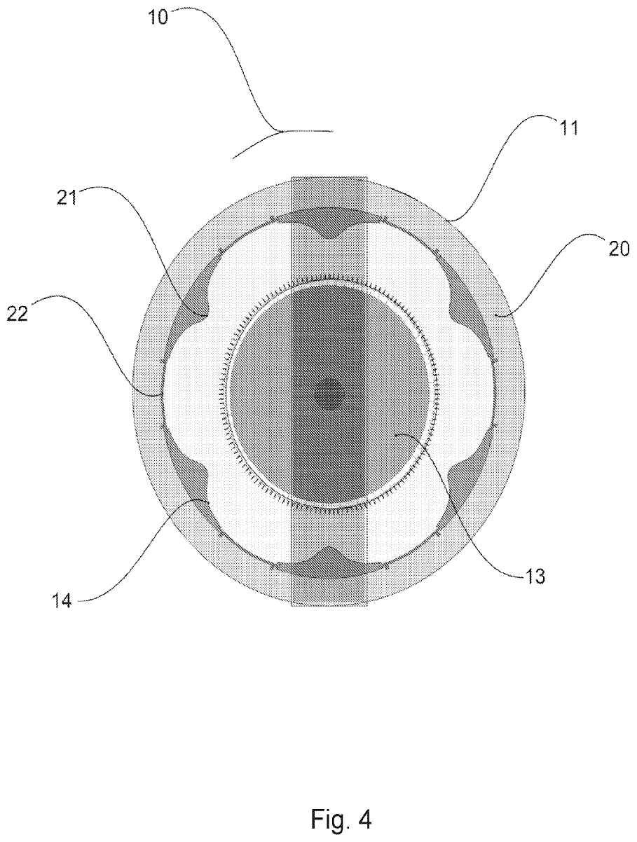

In another preferred embodiment, said inner chamber 12 has a wall 14 provided with six recesses, as shown in the annexed FIG. 4. In a further embodiment, said internal chamber 12 has a wall provided with six recesses adapted to cooperate with six rotating drums, as shown in the annexed FIG. 3.

Preferably, said internal chamber 12 is made of a stainless steel (e.g. AISI 316) sheet which is calendered and electrowelded, and has an average diameter of approximately 500 mm.

The rotating drum 13 may have different heights and diameters, according to the size of the main container 10. In an exemplary embodiment, the rotating drum 13 may have a height of approximately 510 mm and an outer diameter, including the metal spikes 19 arranged in a radial direction, between 90 mm and 250 mm.

Said metal spikes 19 arranged in a radial direction may be made, for example, of stainless steel AISI 304, having a hardness which may vary from 10 to 50 HRC, and may be distributed in a number between 4 and 8 per square cm. Said metal spikes, moreover, may be arranged on suitable staves made of electrophoresed bronze or stainless steel. The number of spikes on the rotating drum 13 varies according to the diameter of the drum itself; for example, if the rotating drum 13 is 510 mm high and has a diameter of 180 mm, there are around 5688 spikes on the outer surface thereof.

Finally, the maximum rotating speed of the rotating drum 13 may be set between 300 and 1350 revolutions per minute. In any case, it is possible to set other rotating speeds without jeopardizing the correct operation of the drum.

Tests which have been performed by employing the procedure and the fraying machine described in the foregoing have produced leather fibers which were long enough to be used in the traditional carded spinning textile systems.

For example, with a mixture of 70% leather fibers and 30% polyamide fibers charged into a traditional carded spinning system, a carded yarn was obtained having the yarn count Nm 11, and it was used to produce samples of woven fabrics (weft/warp plain weave) and knitted fabrics with an extremely comfortable and fresh touch of soft suede, but exhibiting a remarkable mechanical strength.

Other mixed fibers, composed of 50% leather fibers and 50% merino wool with 18 micron fineness have produced a yarn which, once woven and finished as a normal wood cloth (flannel), yielded a fabric having the warmth properties of wool and the comfortable touch of suede microfibers.

Generally speaking, all the leather fibers obtained from the manufacturing waste according to the invention described in the foregoing may be mixed with all the common textile fibers, in order to add the comfortable touch of leather microfibers to the hygroscopicity, which favours the migration of sweat, of the common textile fibers.

Of course, without prejudice to the invention, the embodiments may amply vary with respect to what has been described and illustrated, without departing from the scope of the present invention as defined in the annexed claims.

1. An apparatus for the recovery of processing waste from the tanning and leather industry, comprising a main container provided with an outer lateral wall having at least one discharge sleeve, a floor and an inner wall delimiting an inner chamber, said inner chamber being adapted to contain said waste and an immersion liquid, and to house at least one controlled rotating drum anchored to the floor of said container and provided, on the outer surface thereof, with metal spikes arranged in a radial direction, and at least one filter adapted to allow the passage of the leather fibers, extracted from said waste due to the effect of the action of said controlled rotating drum, outside of said inner chamber towards a collection chamber,
said apparatus being characterized in that said inner wall comprises at least one recess adapted to narrow the passage between said inner wall and said controlled rotating drum.

2. The apparatus of claim 1, characterized in that said main container and said inner chamber are almost cylindrical in shape.

3. The apparatus of claim 1, characterized in that said discharge sleeve is arranged on the outer lateral wall of said main container, in a raised position with respect to the floor of said container.

4. The apparatus claim 1, characterized in that said filter is made in a part of the inner wall by means of a plurality of holes or slots, adapted to allow the passage of the leather fibers but not the passage of the waste.

5. The apparatus claim 1, characterized in that it comprises a sensor adapted to detect, in operation, the viscosity of a suspension of leather fibers flowing downstream of said at least one filter.

6. The apparatus of claim 1, characterized in that it comprises a system for regulating the temperature, configured for regulating, in operation, the temperature of a bath contained in the inner chamber.

7. The apparatus claim 1, characterized in that said metal spikes arranged in a radial direction are distributed over the surface of said controlled rotating drum in a number comprised between 4 and 8 per square cm.

8. An The apparatus of claim 1, characterised in that said inner chamber has an average diameter of about 500 mm and said rotating drum has an overall outer diameter, including the metal spikes comprised between 90 mm and 250 mm.

9. A method for the recovery of processing waste from the tanning and leather industry, comprising the following steps:
a) dividing the waste into groups based on the type of tanning to which it was subjected;
b) if the waste is of the previously tanned type, detanning the waste in order to eliminate the tanning agents present;
c) if the waste is not tanned or has been completely detanned at step b), treating the waste with a glutaraldehyde solution with concentration between 1% and 5%;
d) fraying the waste so as to obtain elongated leather fibers, which are adapted to be used in conventional textile carded spinning systems;
e) treating the extracted fibers with suitable tanning substances;
g) drying the extracted fibers,
said method being characterized in that said step (d) is performed by means of an apparatus according to claim 1.

10. The method of claim 9, characterized in that, between the previous steps e) and f), the following step is performed:
e1) treating the waste by means of softening substances, in order to make the fibers of said waste more slippery and easily separated from one another.

11. The method of claim 9, characterized in that step f) comprises the following steps:
g) dehydrating the fibers by means of a centrifuge or continuous drying machine;
h) drying the fibers with hot air.

12. The method of claim 11, characterized in that, between the previous steps g) and h), the following step is performed:
g1) treating the waste by means of a specific detufting machine, adapted to untangle the heap of fibers of the fiber cake resulting from step g) into groups of ordered fibers.

13. The method claim 9, characterized in that step a) establishes whether the processing waste was treated by mineral tanning—or chrome tanning—or was treated with vegetable tanning using vegetable or synthetic tannins.

14. The method of claim 13, characterized in that, if the processing waste was treated by means of mineral tanning, said step b) is performed by immersing said processing waste inside a drum in a low temperature sulfuric acid-based bath, or into an oxalic acid and toluene-sulfonic acid-based bath buffered with sodium chloride, or into a caustic soda bath having a pH in the range from 10 to 14, at room temperature.

15. The method of claim 13, characterized in that, if the processing waste was treated by vegetable tanning, said step b) is performed by immersing said processing waste inside a drum into a sulfuric acid-based bath or into a pyrophosphoric acid salt-based bath, at room temperature, or into a caustic soda bath having a pH in the range from 10 to 14, at room temperature.

16. A The method of claim 9, characterized in that said glutaraldehyde solution as per step c) has a pH between 3 and 5.

17. A The method of claim 14, characterized in that, after said processing waste has been treated by immersion into a caustic soda bath, it is rinsed and drained and immersed into an oxalic acid bath having a pH around 5 to 5.5.

18. Use of an apparatus of claim 1, characterized in that said immersion liquid is an acidic or an alkaline solution.

19. Use of the apparatus of claim 18, characterized in that said acidic or alkaline solution has a pH between 2.5 and 6.

20. Use of the apparatus of claim 18, characterized in that said acidic or alkaline solution is an acetic acid-based acidic solution.
